(19) United States
(12) Patent Application Publication
(10) Pub. No.: US 2013/0230260 A1
(43) Pub. Date: Sep. 5, 2013

(54) Seam Sealed Reusable Wet Bag For Transporting And Storing Wet Items

(71) Applicants: Nicole Marie Maynard, New Glarus, WI (US); Jesse Anton Maynard, New Glarus, WI (US)

(72) Inventors: Nicole Marie Maynard, New Glarus, WI (US); Jesse Anton Maynard, New Glarus, WI (US)

(21) Appl. No.: 12/625,903

(22) Filed: Nov. 25, 2009

Related U.S. Application Data
(60) Provisional application No. 61/118,132, filed on Nov. 26, 2008.

(51) Int. Cl. B65D 30/08; B31B 1/90; B31B 1/64; B31B 39/00; B65D 30/22; B65D 33/16

(52) U.S. Cl. 383/40; 383/59; 383/61.1; 383/108; 383/113; 493/189; 493/217; 493/214

(57) ABSTRACT

A seam sealed wet bag for transporting and storing wet items and a process for marking same.

### CROSS-REFERENCES TO RELATED APPLICATIONS

This application claims priority from U.S. Provisional Application Ser. No. 61/118,132 filed Nov. 26, 2008, which is hereby incorporated herein by reference in its entirety.

### TECHNICAL FIELD

The present invention relates to wet bags, and more particularly, some embodiments relate to a seam sealed wet bag.

### BACKGROUND OF THE INVENTION

The present invention relates to wet bags, and more particularly, some embodiments relate to a seam sealed waterproof wet bag and a method of making same. A flaw with many wet bags presently being sold is that they wick or leak at the seams. Often this is due to the fact that the seams are sewn with no other measures to prevent address the holes in the waterproof material of the wet bag at the sewn seams. The present invention addresses this problem.

### BRIEF SUMMARY OF EMBODIMENTS OF THE INVENTION

According to one embodiment of the invention, a seam sealed wet bag for transporting and storing wet items comprises an outer decorative bag and an inner bag resistant to wetting, connected to and enveloped by the outer decorative bag. The inner bag has at least one side formed from two side edges seam sealed together via a heat and pressure process to form a seam sealed region.

In a variant, the seam sealed wet bag has a plurality of stitches sewn through the seam sealed region, along the length of the side.

In another variant, the seam sealed wet bag has a bag closing mechanism for repeatably opening and closing the wet bag. Optionally, the inner bag and outer bag are connected via the bag closing mechanism.

In a further variant, the seam sealed wet bag has a pocket disposed in the outer bag for storing dry items. The seam sealed wet bag contains a location for storing wet items in the inner bag and a location for storing dry items in the pocket of the outer bag and thus dry and wet items can be stored or toted separately, without the need for water repellant material in the dry pocket of the outer bag.

In still another variant of the seam sealed wet bag, the seam seal is formed from a process using heat at in temperature range from about 300 degrees to about 360 degrees Fahrenheit and a pressure in a range from about 80 PSI to about 90 PSI.

In yet a further variant of the seam sealed wet bag, the bag closing mechanism is a zipper assembly, comprising two tracks each connected to a side support. The outer bag and the inner bag are attached to the zipper side supports.

In another variant of the seam sealed wet bag, the inner bag comprises at least two non-continuous seam sealed sides formed from two unconnected side edges seam sealed together via a heat and pressure process to form a seam sealed region.

In a further variant of the seam sealed wet bag, the inner bag comprises three seam sealed sides. Two sides are formed from two unconnected side edges seam sealed together via a heat and pressure process to form a seam sealed region. A third side is formed from two sides of a single piece of material connected via a fold in the material and seam sealed together via a heat and pressure process to form a seam sealed region.

In still another variant of the seam sealed wet bag, the inner bag comprises a material having a water repellant coating.

In yet a further variant of the seam sealed wet bag, the coating is a polyurethane coating and the bag is made from a polyester material.

In another variant, a seam sealed wet bag for transporting and storing wet items that is resistant to wetting, comprises two side panels having a water repellant coating. The wet bag comprises two seams formed from two side edges having the water repellant coating seam sealed together via a heat and pressure process to form a seam sealed region. A plurality of stitches is sewn through the seam sealed region, along the length of the side.

In a further variant, an apparatus for storing or toting wet and dry items, comprises: a bag closing assembly, comprising side supports; an outer decorative bag having to side panels each attached to a side support; and an inner bag comprising the seam sealed wet bag described in the immediate previous section, that is enveloped by the outer decorative bag, and has two side panels having a water repellant coating and each attached to a respective side support of the bag closing assembly.

In yet another variant, the apparatus for storing or toting wet and dry items has a pocket disposed in a side panel of the outer decorative bag. The apparatus contains a location for storing wet items in the inner bag and a location for storing dry items in the pocket of the outer bag and thus dry and wet items can be stored or toted separately, without the need for water repellant material in the dry pocket of the outer bag.

In still a further variant, a process for making a seam sealed wet bag comprises: providing a piece of fabric having a water repellant coating; folding the fabric into two halves and aligning side edges of the halves; and applying heat and pressure for a predetermined length of time to the aligned side edges to form a seam sealed region along the side edges. A water repellant bag is thus formed with an open end.

In another variant of the process for making a wet bag: the heat and pressure are applied together for between 8 and 12 seconds; the heat is applied at a temperature range from about 300 to about 360 degrees Fahrenheit; and the pressure is applied from about 80 PSI to about 90 PSI.

In a further variant of the process for making a wet bag, the stitching is sewn along the side edges of the fabric before heat and pressure is applied.

In still another variant of the process for making a wet bag, stitching is sewn along the side edges of the fabric after heat and pressure is applied.

In yet a further variant of the process for making a wet bag, the process may optionally comprise: connecting the open end of the bag to a bag closing mechanism; and enveloping an outer bag having an open around the water repellant bag and connecting the outer bag to the bag closing mechanism.

In another variant of the process for making a wet bag, the heat and pressure are applied by a rotating instrument.

In a further variant of the process for making a wet bag, the heat and pressure are applied by a non-rotating instrument.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a diagram of a seam sealed wet bag in accordance with the principles of the invention with a portion cut away for the purposes of illustration;

FIG. 2 is a diagram of a seam sealed wet bag in illustrating an optional outer pocket;

FIG. 3 is an illustration of a piece of fabric used in the process of constructing a waterproof inner bag;

FIG. 4 is an illustration of a waterproof inner bag;

FIG. 5A is an illustration of a variant of a water repellant inner bag having a sewn seam;

FIG. 5B is an illustration of a variant of a water repellant inner bag having a sewn seam and optional sealed region along the fold;

FIG. 5C is an illustration of a variant of a water repellant inner bag constructed to two pieces of fabric having sealed seam regions on three sides and optional sewn seams;

FIG. 6A is an illustration of an apparatus that may be used for making a seam sealed wet bag;

FIG. 6B is a conceptual diagram of another apparatus that may be used for making seam sealed wet bags.

FIG. 7 is illustration of the relationship of the inner and out bags;

FIG. 8 is a sectional view of the wet bag of FIG. 1 taken along the line 8′-8′;

FIG. 9 is a sectional view of the wet bag of FIG. 2 taken along the line 9′-9′;

FIG. 10 is a flow chart of a process of making a seam sealed wet bag; and

FIG. 10 is a flow chart of another process of making a seam sealed wet bag.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention is directed toward a seam sealed reusable wet bag 10 for transporting and storing wet and or dirty items. The wet bag 10 may be reusable, washable and dryable with conventional clothes washing equipment. The wet bag can store liquid soaked items, and prevent the passage of the liquid, for example water, to the environment outside the bag.

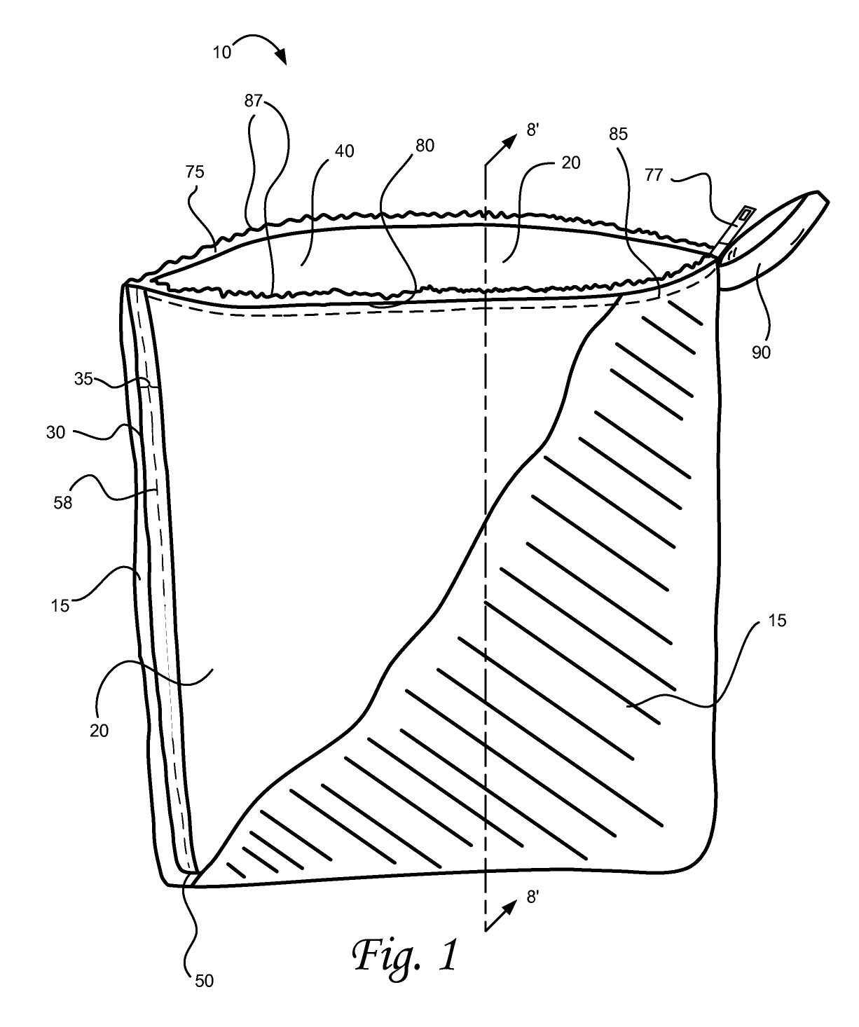

According to one embodiment of the invention, referring to FIG. 1, a seam sealed reusable wet bag 10 comprises a outer cotton bag 15 and a seam sealed water repellant inner bag 20. FIG. 1 is a diagram of a wet bag 10 with a portion of the outer bag 15 cut away to expose the inner bag 20 for the purposes of illustration. The inner 20 and outer 15 bags may be made of fabric designed to be washable and dryable with conventional automatic clothes washing equipment.

In one variant, the outer bag 15 is a dry bag and generally will not prevent moisture from escaping, and it may be constructed of cotton. The outer bag 15 is preferably aesthetically pleasing and may contain a pleasing design or pattern for the user.

The inner bag 20 comprises an opening 25 and two side edges 30 each having a seam seal 35 formed by heat and pressure applied over time. The inside surface of inner bag 20 contains a water repellant coating 40. In one variant, the water repellant coating may comprise FABUTHANE® which is an aromatic polyether polyurethane film/sheet product. Other water repellant coatings may be used which are capable of bonding to fabric and being heat sealed with temperature and pressure to another fabric surface containing the coating. Other coated fabrics may include, ProCare™ vinyl or polyester fabrics with either a vinyl or polyurethane coating.

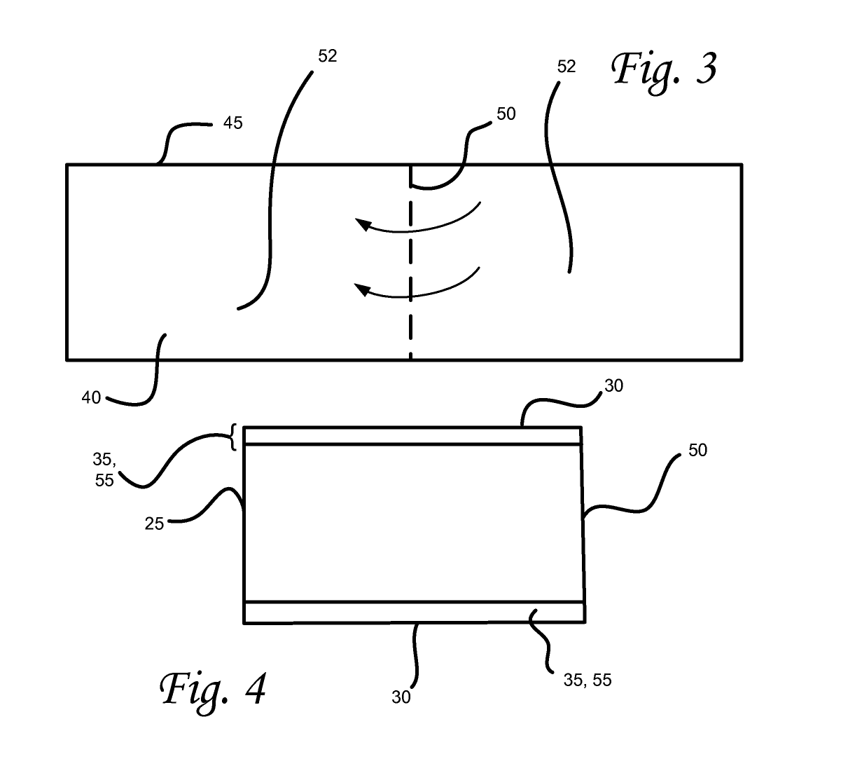

The configuration and construction of the inner bag 20 is illustrated in FIGS. 3-6. Referring to FIG. 3, in a variant, the inner bag comprises at least two non-continuous seam sealed sides formed from two unconnected side edges seam sealed together via a heat and pressure process to form a seam sealed region.

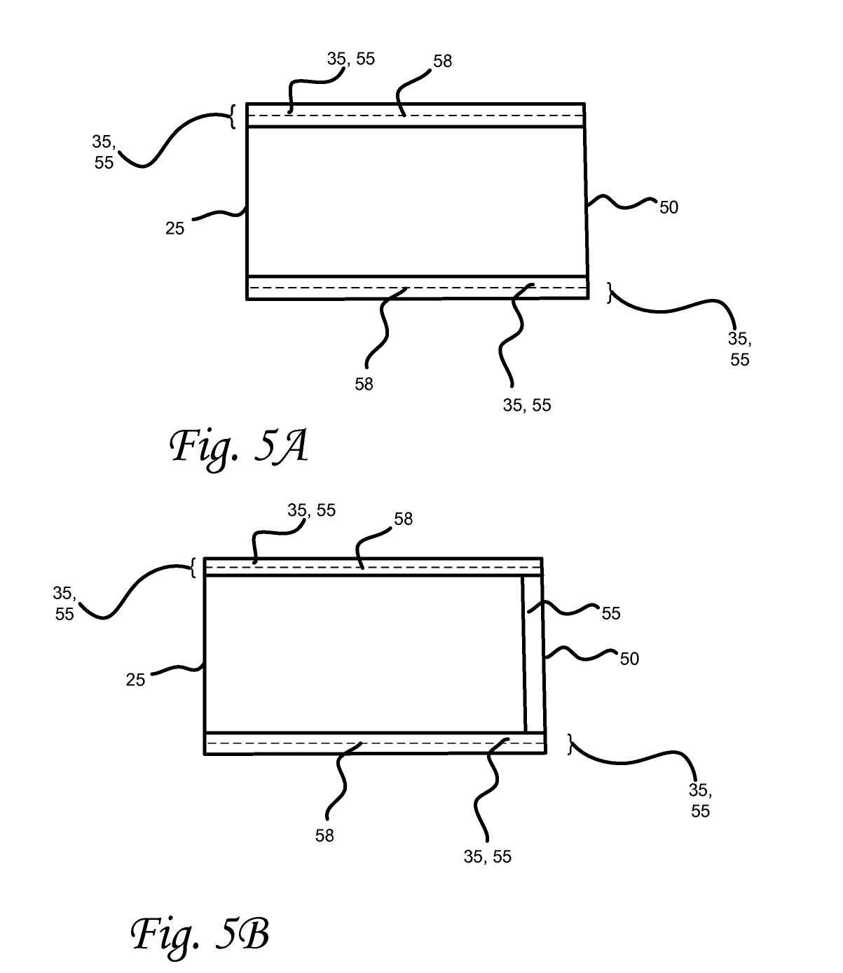

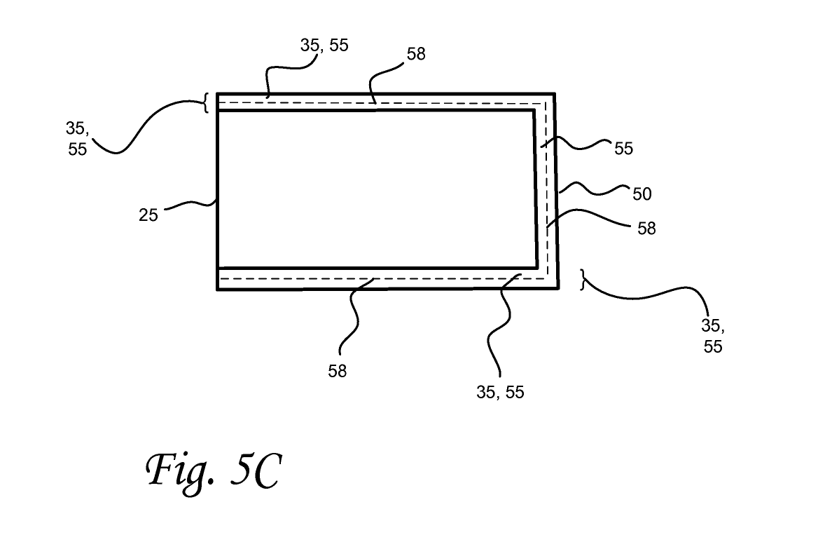

In another variant, a water repellant coated fabric 45 may be provided with generally a rectangular shape. The fabric 45 is folded to form a fold 50 along a middle of the fabric 45, so that two faces 52 of the fabric 45 containing the water repellant coating are placed adjacent to each other. Optionally, referring to FIGS. 1 and 5A, the fabric may be sewn 58 down the middle of a region 55 where the two faces 52 of fabric 45 will be sealed together. The sealed region runs along the side of the bag. A bag having a combined seal 35 and sewn seam 58 comprising stitches, may advantageously provide extra strength and waterproofing ability whereby water or liquid is prevented from escaping the bag through the combined sides 30. Also, the sewn seam 58 also helps to hold the fabric 45 in a configuration for applying heat and pressure to form the seal 35. However, the inner bag may optionally be constructed without stitches and with the seam seal only. Construction in this manner provides the advantage of quicker construction of the bag over creating the seam with stitches for sewing.

After the fabric 45 is folded (and optionally sewn 58), the fabric 45 is sealed along a rectangular region 55 by applying heat and pressure over time with a heat sealing apparatus. The region may vary in width, for example, various embodiments may have a seam sealed region between 0.25 and 1 inch in width. In a preferred embodiment, the width is about 0.5 inches.

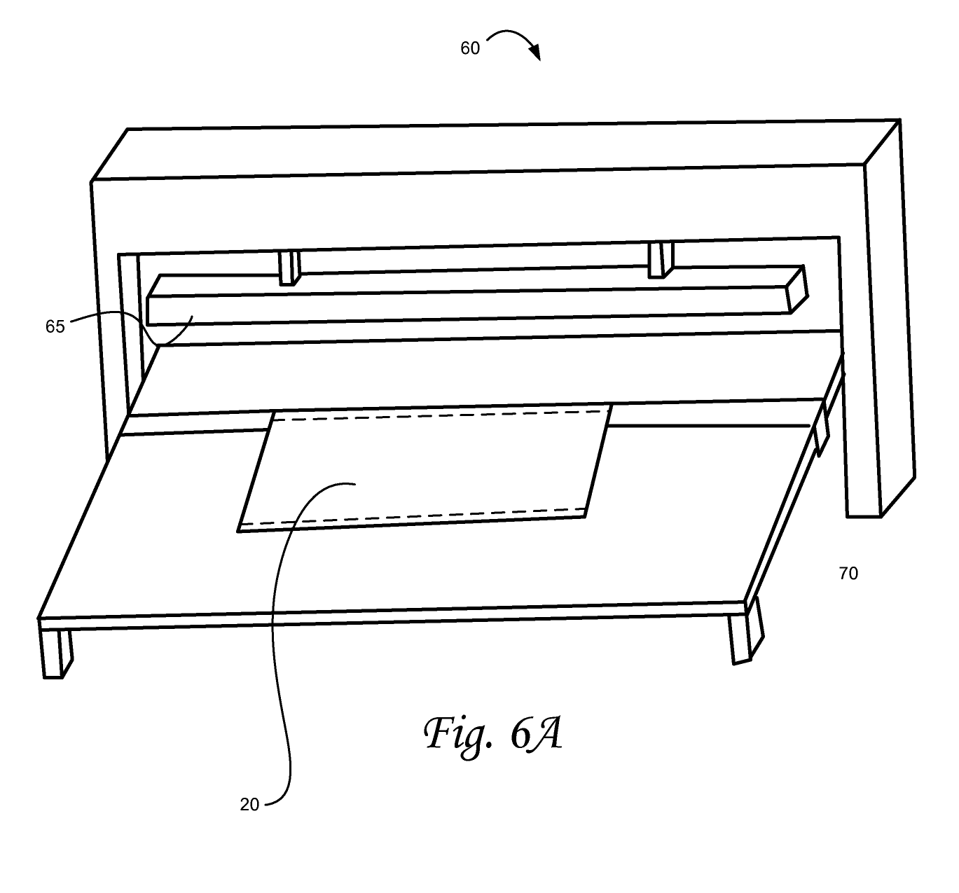

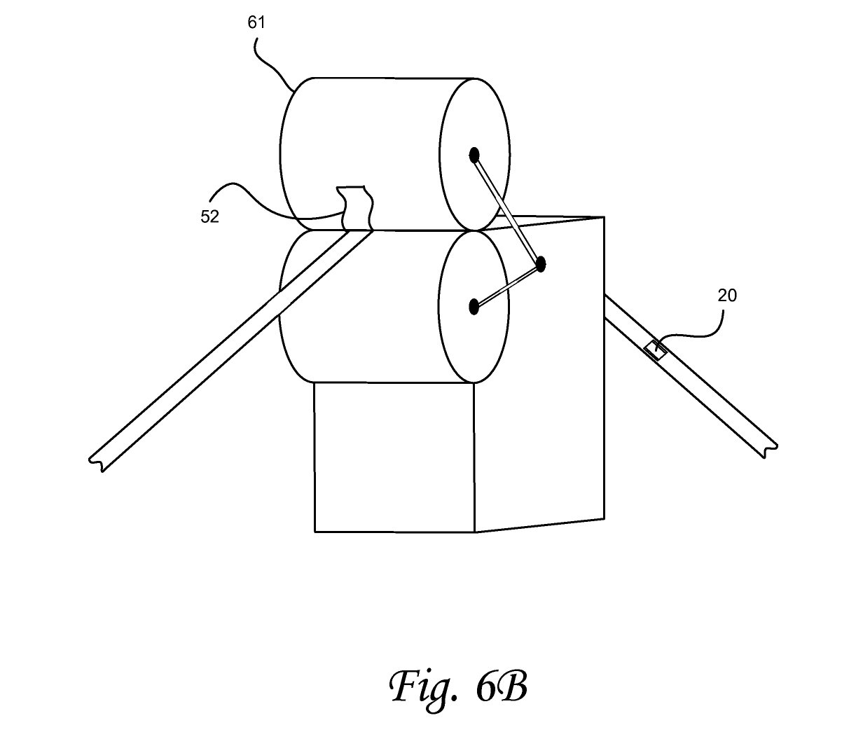

An example one type of apparatus 60 which may be used is shown in FIG. 6A. Optionally, the heat sealing apparatus 60 may comprise an upper heated bar 65 that is 0.5 inches in thickness and preferably has features to adjust the temperature and pressure settings. The inner bag 20 is set under the bar 65 and the bar 65 is lowered to provide mechanical pressure on the region 55 where the two faces 52 will be sealed together. The bar 65 forms a 0.5 inch seal 35 on the sides 30 of the bag 20. Optionally, a second lower heated bar 70 may be used directly below the upper heated bar 65. Optionally, referring to FIG. 5B, the fold 50 may be seam sealed with the same temperature, pressure and times settings as the other seams form a seam sealed region 55 along the fold. Optionally, referring to FIG. 5C, the inner bag 20 may be constructed from 2 separate pieces, for example, rectangular pieces and the seam sealed applied to three sides to form a wet bag. Optionally, the inner bag 20 constructed from two separate pieces may have stitches 58 along the seam sealed regions 55.

Another example of an apparatus 61 which may be used to create the seal is conceptually illustrated in FIG. 6B and may comprise rollers for continuously seam sealing the fabric to construct the wet bags 10.

In one variant, a 1 millimeter thickness of FABUTHANE® fabric is used as the fabric for the inner bag 20. For a 1 millimeter thickness of FABUTHANE® a temperature of 330 degrees Fahrenheit, a time of 10 seconds of application, and at 80 PSI are used to form the seam seal 35. Other thickness fabric may be used, for example, a 2 millimeter thickness fabric, however, a 2 millimeter thickness fabric will require a different temperature, pressure and time setting for the apparatus 60 to properly form the seal 35. A higher PSI setting may be used if the temp and time is decreased.

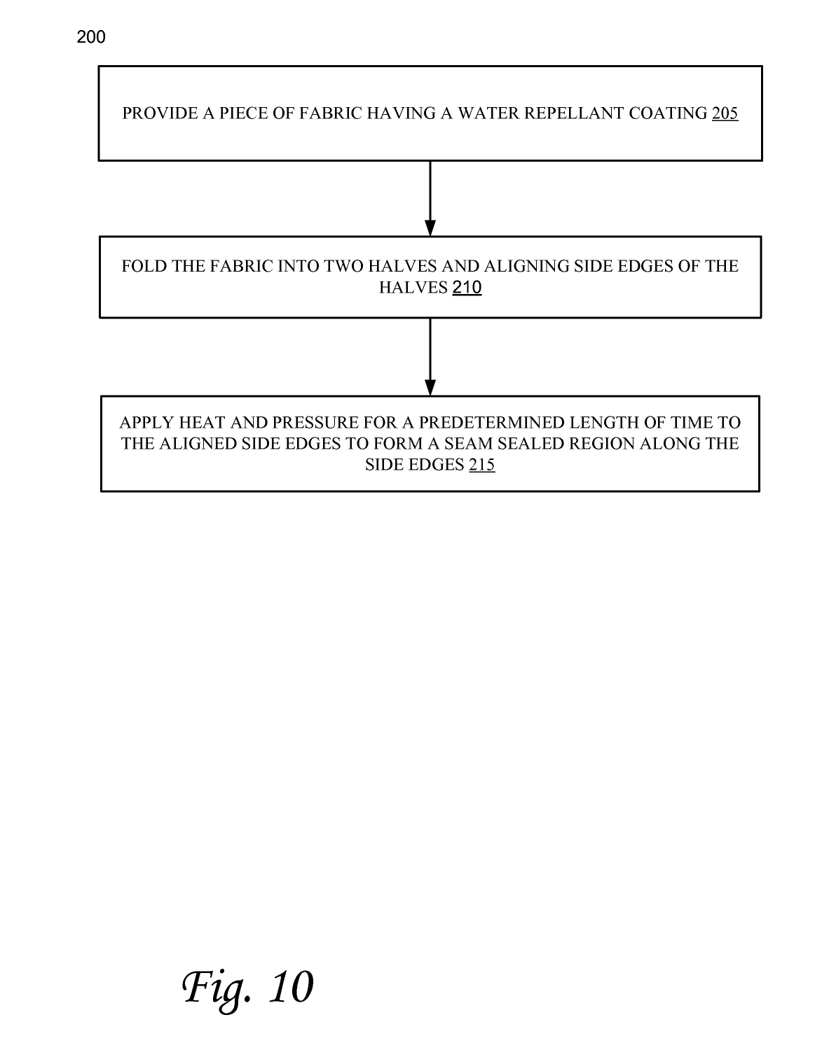

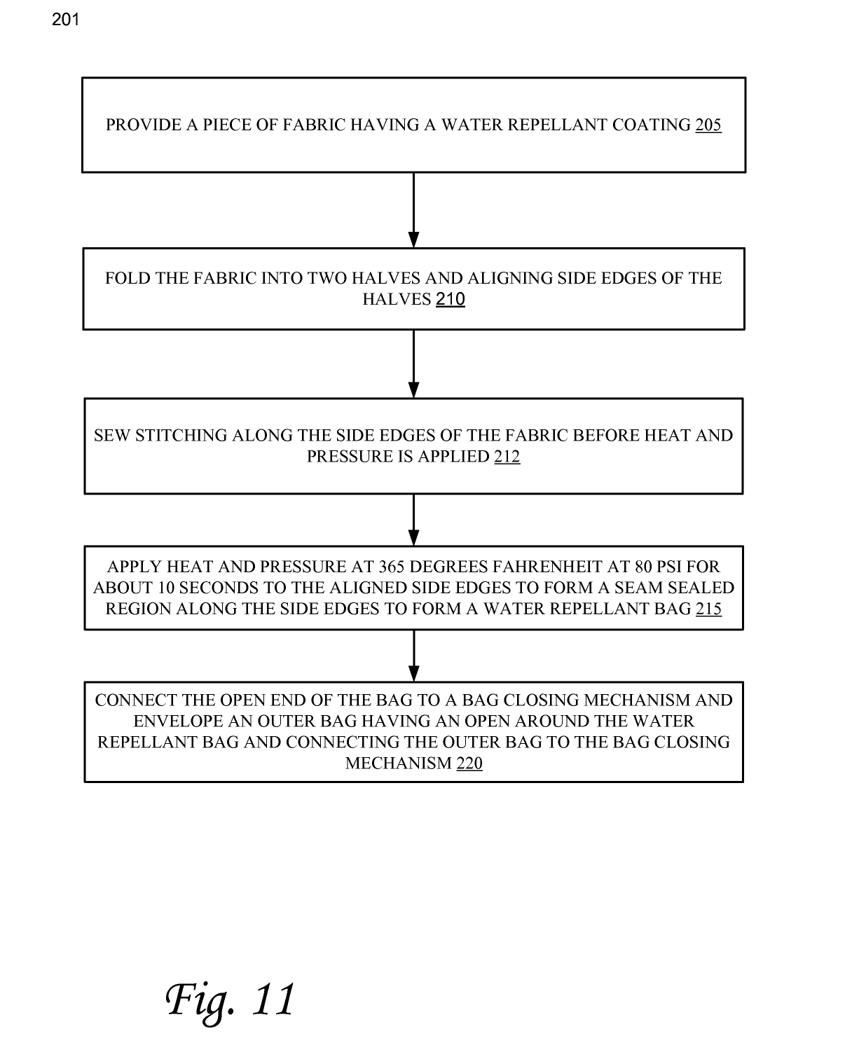

In another variant, referring to FIG. 10, a process 200 for making a seam sealed wet bag comprises: in a step 205 providing a piece of fabric having a water repellant coating; in a step 210 folding the fabric into two halves and aligning side edges of the halves; and in a step 215 applying heat and pressure for a predetermined length of time to the aligned side edges to form a seam sealed region 55 along the side edges. A water repellant bag is formed with an open end.

In a further variant 201 of the process for making a wet bag, referring to FIG. 11, step 215 can be carried out as follows: the heat and pressure are applied together for between 8 and 12 seconds; the heat may be applied at a temperature in a range from about 300 to about 360 degrees Fahrenheit, but preferably about 330 degrees Fahrenheit; and the pressure may be applied in a range from about 80 PSI to about 90 PSI, but preferably about 80 PSI.

In a further variant of the process for making a wet bag, referring to in a step 212 stitching is sewn along the side edges of the fabric before heat and pressure is applied.

In still another variant of the process for making a wet bag, stitching is sewn along the side edges of the fabric after heat and pressure is applied.

In yet a further variant of the process for making a wet bag, the process further comprises in a step 220: connecting the open end of the bag to a bag closing mechanism; and enveloping an outer bag having an open around the water repellant bag and connecting the outer bag to the bag closing mechanism.

The application of heat and pressure forms a water repellant seal 35 over the region 55. The seal 35 prevents the escape of water through the seal 35. A seal 35 is formed on both sides 30 of the folded fabric 45, so that the fold 50 and two seals 35 define a bag 20 having an opening 25, capable of preventing moisture and water and other liquids from escaping. The seam seal also advantageously provides a more aesthetically please appearance than stitching alone.

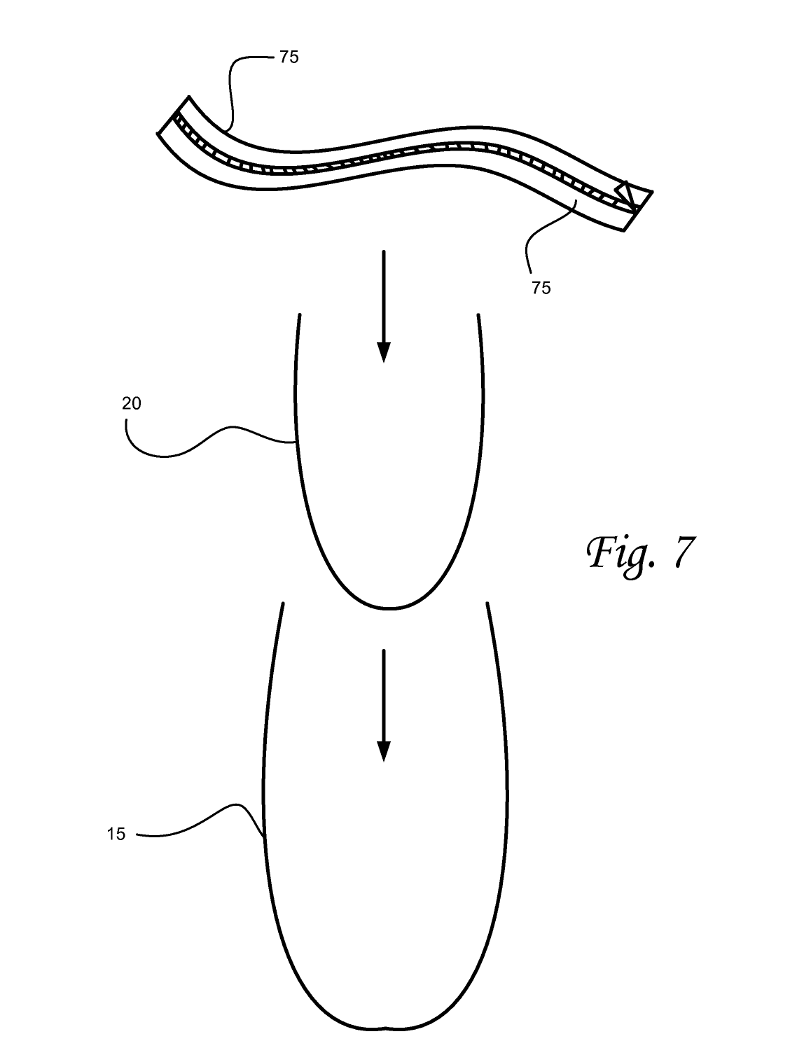

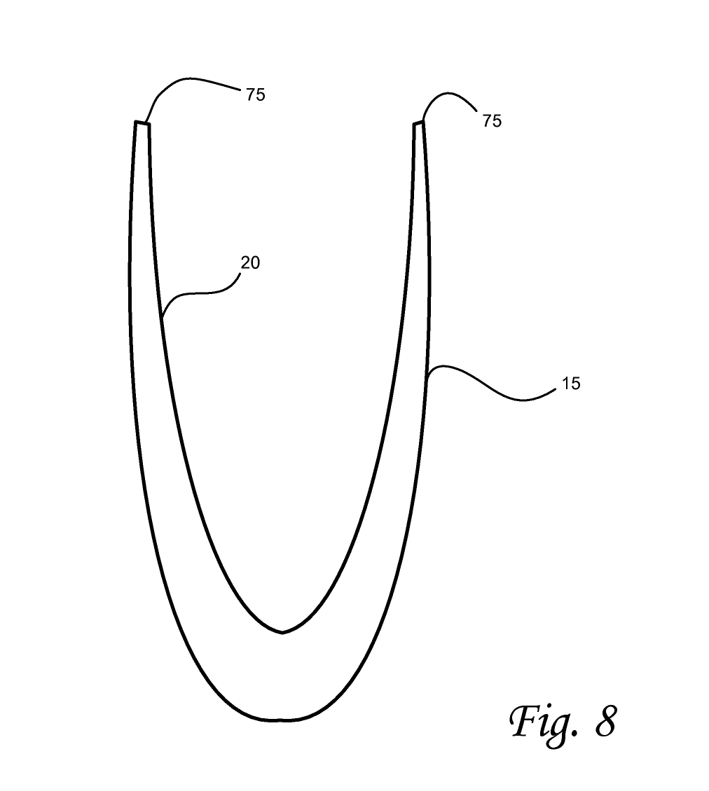

Sectional views of the bags 15, 20 taken along the line 8′-8′ in FIG. 1 are illustrated in FIGS. 7 and 8. Referring to FIGS. 7 and 8, in one variant the seam sealed wet bag 10 is optionally constructed with the inner bag 20 inside and enveloped by an outer bag 15 and both bags 15, 20 are sewn to side supports 75 of a bag closing mechanism 77 along sewn seams 80, 85, illustrated in FIG. 1. The bag closing mechanism is for repeatable opening and closing the bag. In a variant, the bag closing mechanism may be a zipper assembly and the side supports 75 hold zipper tracks 87.

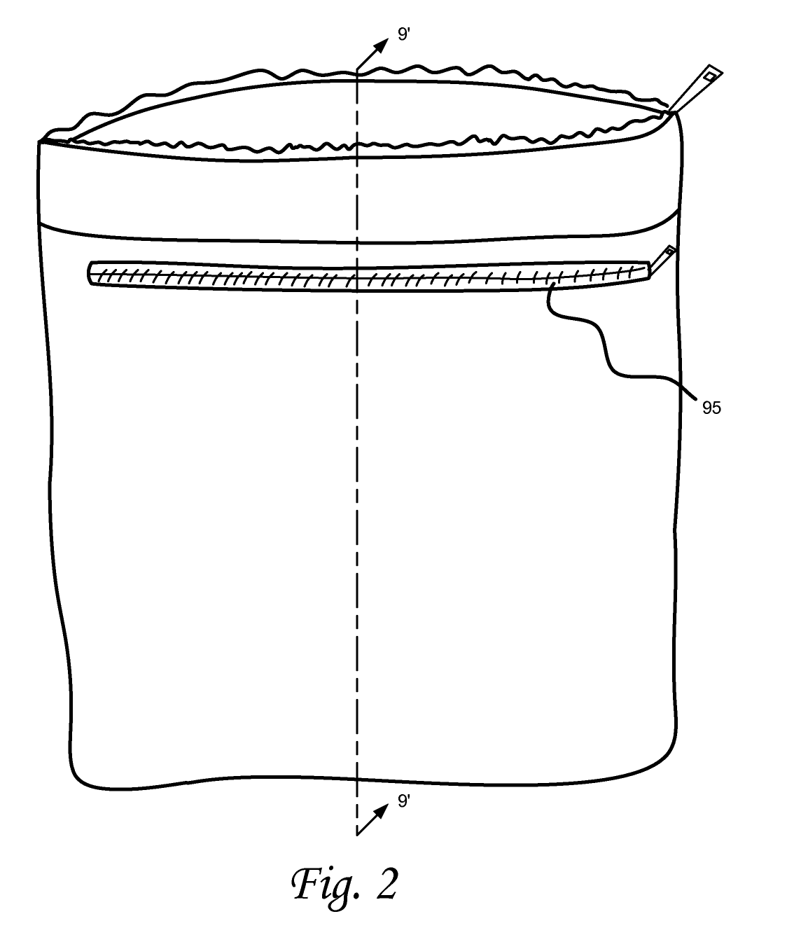

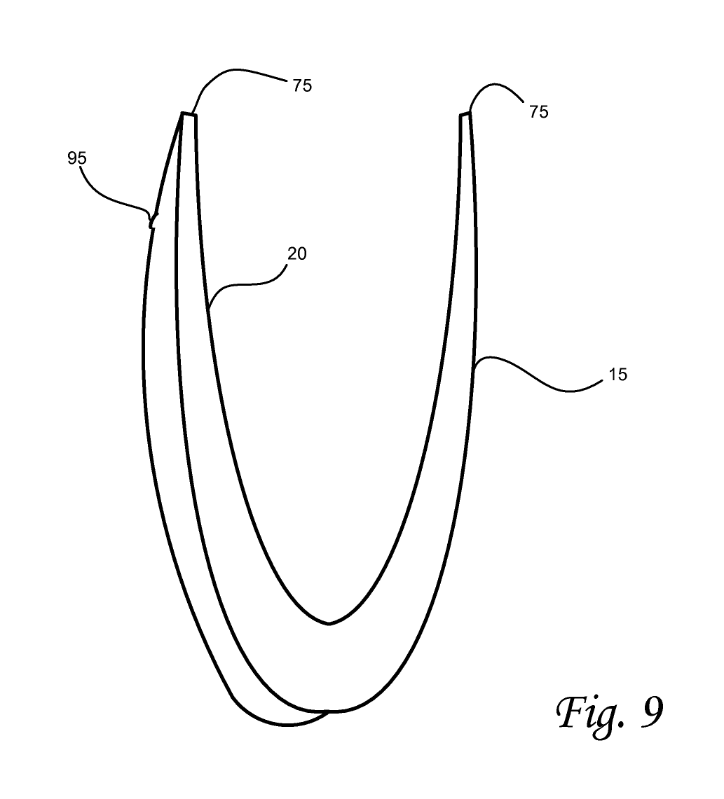

In a variant of the seam sealed wet bag 10, referring to FIG. 1, the bag 10 includes a handle 90. In another variant of the seam sealed wet bag 10, referring to FIGS. 2 and 9, the bag 10 may include an outer zippered pocket 95 located on a side panel 105 the outer bag 15. The outer bag may be decorative and may be formed form side panels 105. The side panels may include the pocket 95 for storing dry items. Because the inner bag 20 is formed from panels coated with a water repellant substance, wet items can be stored or toed there and dry items can be stored or toted in the pocket 95 of the outer bag 15, without the need for forming the outer pocket with expensive water repellant coated fabrics.

While various embodiments of the present invention have been described above, it should be understood that they have been presented by way of example only, and not of limitation Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A seam sealed wet bag for transporting and storing wet items, comprising:
an outer decorative bag;
an inner bag resistant to wetting, connected to and enveloped by the outer decorative bag, comprising at least one side formed from two side edges seam sealed together via a heat and pressure process to form a seam sealed region.

2. The seam sealed wet bag of claim 1, further comprising a plurality of stitches sewn through the seam sealed region, along the length of the side.

3. The seam sealed wet bag of claim 1, further comprising a bag closing mechanism for repeatably opening and closing the wet bag, wherein the inner bag and outer bag are connected via the bag closing mechanism.

4. The seam sealed wet bag of claim 3, further comprising a pocket disposed in the outer bag for storing dry items;
wherein the seam sealed wet bag contains a location for storing wet items in the inner bag and a location for storing dry items in the pocket of the outer bag and thus dry and wet items can be stored or toted separately, without the need for water repellant material in the dry pocket of the outer bag.

5. The seam sealed wet bag of claim 4, wherein the seam seal is formed from a process using heat at in temperature range from about 300 degrees to about 360 degrees Fahrenheit and a pressure in a range from about 80 PSI to about 90 PSI.

6. The seam sealed wet bag of claim 1, wherein the bag closing mechanism is a zipper assembly, comprising two tracks each connected to a side support; wherein the outer bag and the inner bag are attached to the zipper side supports.

7. The seam sealed wet bag of claim 1, wherein the inner bag comprises at least two non-continuous seam sealed sides formed from two unconnected side edges seam sealed together via a heat and pressure process to form a seam sealed region.

8. The seam sealed wet bag of claim 1, wherein the inner bag comprises three seam sealed sides:
wherein two sides are formed from two unconnected side edges seam sealed together via a heat and pressure process to form a seam sealed region; and
wherein a third side is formed from two sides of a single piece of material connected via a fold in the material and seam sealed together via a heat and pressure process to form a seam sealed region.

9. The seam sealed wet bag of claim 1, wherein the inner bag comprises a material having a water repellant coating.

10. The seam sealed wet bag of claim 9, wherein the coating is a polyurethane coating and the bag is made from a polyester material.

11. A seam sealed wet bag for transporting and storing wet items that is resistant to wetting, comprising:
two side panels having a water repellant coating;
wherein the wet bag comprises two seams formed from two side edges having the water repellant coating seam sealed together via a heat and pressure process to form a seam sealed region; and
a plurality of stitches sewn through the seam sealed region, along the length of the side.

12. An apparatus for storing or toting wet and dry items, comprising:
a bag closing assembly, comprising side supports;
an outer decorative bag having to side panels each attached to a side support; and
an inner bag comprising the seam sealed wet bag of claim 11, enveloped by the outer decorative bag, and having two side panels having a water repellant coating and each attached to a respective side support of the bag closing assembly.

13. The apparatus for storing or toting wet and dry items of claim 12, further comprising a pocket disposed in a side panel of the outer decorative bag;
wherein the apparatus contains a location for storing wet items in the inner bag and a location for storing dry items in the pocket of the outer bag and thus dry and wet items can be stored or toted separately, without the need for water repellant material in the dry pocket of the outer bag.

14. A process for making a seam sealed wet bag, comprising:
providing a piece of fabric having a water repellant coating;
folding the fabric into two halves and aligning side edges of the halves;
applying heat and pressure for a predetermined length of time to the aligned side edges to form a seam sealed region along the side edges;
wherein a water repellant bag is formed with an open end.

15. The process for making a wet bag of claim 14, wherein:
the heat and pressure are applied together for between 8 and 12 seconds;
the heat is applied at a temperature range from about 300 to about 360 degrees Fahrenheit; and
the pressure is applied from about 80 PSI to about 90 PSI.

16. The process for making a wet bag of claim 14, wherein stitching is sewn along the side edges of the fabric before heat and pressure is applied.

17. The process for making a wet bag of claim 14, wherein stitching is sewn along the side edges of the fabric after heat and pressure is applied.

18. The process for making a wet bag of claim 14, further comprising:
connecting the open end of the bag to a bag closing mechanism;
enveloping an outer bag having an open around the water repellant bag and connecting the outer bag to the bag closing mechanism.

19. The process for making a wet bag of claim 14, wherein the heat and pressure are applied by a rotating instrument.

20. The process for making a wet bag of claim 14, wherein the heat and pressure are applied by a non-rotating instrument.
